(19) United States
(12) Patent Application Publication
(10) Pub. No.: US 2025/0273746 A1
(43) Pub. Date: Aug. 28, 2025

(54) APPARATUS FOR MANUFACTURING ALL SOLID BATTERY

(71) Applicants: MEERE COMPANY INC., Hwaseong-si Gyeonggi-do (KR); SAMSUNG SDI CO., LTD., Yongin-si Gyeonggi-do (KR)

(72) Inventors: Ja Woo LEE, Hwaseong-si Gyeonggi-do (KR); Hae Young JEON, Anseong-si Gyeonggi-do (KR); Gu Yun JUNG, Cheonan-si Chungcheongnam-do (KR)

(73) Assignees: MEERE COMPANY INC., Hwaseong-si Gyeonggi-do (KR); SAMSUNG SDI CO., LTD., Yongin-si Gyeonggi-do (KR)

(21) Appl. No.: 19/202,313

(22) Filed: May 8, 2025

Related U.S. Application Data
(63) Continuation of application No. PCT/KR2023/017826, filed on Nov. 8, 2023.

(30) Foreign Application Priority Data
Nov. 9, 2022 (KR) 10-2022-0148990
Dec. 29, 2022 (KR) 10-2022-0188254

(51) Int. Cl. H01M 10/0585

(52) U.S. Cl. CPC H01M 10/0585

(57) ABSTRACT

An embodiment of the present disclosure provides an apparatus for manufacturing an all-solid battery, the apparatus including a holder having a surface on which a workpiece is seated, a pressurizing unit arranged above the surface of the holder and configured to pressurize the workpiece seated on the holder to a preset pressure, and a heating unit arranged in an area of the holder or the pressurizing unit and configured to apply heat to the workpiece.

### CROSS-REFERENCE TO RELATED APPLICATIONS

This application is continuation of International Application No. PCT/KR2023/017826 filed on Nov. 8, 2023, which claims priority to Korean Patent Application No. 10-2022-0148990 filed on Nov. 9, 2022, and Korean Patent Application No. 10-2022-0188254 filed on Dec. 29, 2022, the entire contents of which are herein incorporated by reference.

### TECHNICAL FIELD

The present disclosure relates to an apparatus for manufacturing an all-solid battery.

### BACKGROUND ART

Lithium-ion batteries have reached the limit of performance improvement, and recently, all-solid batteries which replace an electrolyte with a solid electrolyte have attracted attention. Compared to secondary batteries which use liquid electrolytes, all-solid batteries do not experience electrolyte decomposition due to overcharging of batteries and also have high cycle durability and energy density.

Since the electrolyte is a solid, the electrolyte is safe due to less risk from temperature change and external impact, and energy density is also high, compared to lithium-ion batteries.

On the other hand, it is known that the contact resistance between active material particles responsible for the battery reaction or between active material particles and solid electrolyte particles has a significant influence on the internal resistance of the battery in the all-solid battery, and technology is proposed which suppresses an increase in internal resistance or the like by improving the contact between the active material particles or between the active material particles and the solid electrolyte particles.

As a method of manufacturing an all-solid battery to improve the contact between such particles, Korean Patent Publication No. 10-2022-0089332 proposes a method of bringing particles into close contact with each other so that pores between particles are minimized and proposes methods of manufacturing an all-solid battery by pressurizing the all-solid battery.

However, a method of manufacturing an all-solid battery, which was proposed in the past, has problems in that pores in the all-solid battery are not sufficiently removed, or the all-solid battery is damaged during a pressurizing process, resulting in a degradation in battery performance. Therefore, there is a need for an apparatus for manufacturing an all-solid battery, which prevents the all-solid battery from being damaged even during a pressurizing process while sufficiently removing pores in the all-solid battery.

### SUMMARY

### Technical Problem

The technical problem to be achieved by the present disclosure is to provide an apparatus for manufacturing an all-solid battery, which is capable of sufficiently removing pores in the all-solid battery.

In addition, another technical problem to be achieved by the present disclosure is to provide an apparatus of manufacturing an all-solid battery, which is capable of manufacturing a battery cell which is uniformly pressurized throughout.

In addition, another technical problem to be achieved by the present disclosure is to provide an apparatus for manufacturing an all-solid battery, which prevents the all-solid battery from being damaged even during a pressurizing process.

The technical problems to be achieved by the present disclosure are not limited to those described above, and other technical problems that are not described herein will be clearly understood from the following description by those of ordinary skill in the art to which the present disclosure belongs.

### Solution to Problem

To achieve the technical problems, an embodiment of the present disclosure provides an apparatus for manufacturing an all-solid battery, the apparatus including a holder having a surface on which a workpiece is seated, a pressurizing unit arranged above the surface of the holder and configured to pressurize the workpiece seated on the holder to a preset pressure, and a heating unit arranged in an area of the holder or the pressurizing unit and configured to apply heat to the workpiece.

To achieve the technical problems, an embodiment of the present disclosure provides an apparatus for manufacturing an all-solid battery, the apparatus including a holder having a surface on which a workpiece is seated, a pressurizing unit arranged above the surface of the holder and configured to pressurize the workpiece seated on the holder to a preset pressure, and a buffer auxiliary member arranged in an area adjacent to the workpiece and configured to distribute a pressure applied to the workpiece.

### Advantageous Effects of Invention

According to an embodiment of the present disclosure, an apparatus for manufacturing an all-solid battery, which is capable of sufficiently removing pores in the all-solid battery, may be provided.

In addition, according to an embodiment of the present disclosure, an apparatus for manufacturing an all-solid battery, which is capable of manufacturing a battery cell which is uniformly pressurized throughout, may be provided.

In addition, according to an embodiment of the present disclosure, an apparatus for manufacturing an all-solid battery, which prevents the all-solid battery from being damaged even during a pressurizing process, may be provided.

The effects of the present disclosure are not limited to those described above and should be understood as including all effects that may be inferred from the configurations of the present disclosure set forth in the detailed description or the claims of the present disclosure.

### BRIEF DESCRIPTION OF DRAWINGS

FIG. 1 is an example diagram of an apparatus for manufacturing an all-solid battery, which is provided according to an embodiment of the present disclosure.

FIGS. 2A and 2B are an example diagram of an apparatus for manufacturing a battery cell, according to an embodiment of the present disclosure.

FIGS. 3A and 3B are an example diagram of an apparatus for manufacturing a battery cell, according to an embodiment of the present disclosure.

FIGS. 4A and 4B are an example diagram of an apparatus for manufacturing a battery cell, according to an embodiment of the present disclosure.

### DETAILED DESCRIPTION

Hereinafter, the present disclosure will be described with reference to the accompanying drawings. However, the present disclosure may be implemented in various different forms and is not limited to embodiments described herein. To clearly explain the present disclosure, parts irrelevant to the description are omitted in the drawings and similar reference numerals are assigned to similar parts throughout the specification.

While the terms such as “first,” “second,” “A,” and “B” may be used to describe various elements, the elements should not be limited by the terms. These terms are only used to distinguish one element from another. For example, while not departing from the scope of the present disclosure, a first element may be referred to as a second element, and similarly, a second element may be referred to as a first element. The term “and/or” as used herein includes a combination of a plurality of related listed elements or any one of a plurality of related listed elements.

It will be understood that when a portion is referred to as being “connected to (coupled to or in contact with)” another portion, it may be “directly connected to” the other portion or “indirectly connected to” the other portion with intervening members therebetween. In addition, the expression “a portion includes a certain element” means that the portion further includes other elements rather than excludes other elements unless otherwise stated.

The terms as used herein are only used to describe particular embodiments and are not intended to limit the present disclosure. The singular forms as used herein are intended to include the plural forms as well unless the context clearly indicates otherwise.

The terms “comprise,” “include,” or “have” as used in the present specification are inclusive and therefore specify the presence of one or more stated features, integers, steps, operations, elements, components, or any combination thereof, but do not preclude the presence or addition of one or more other features, integers, steps, operations, elements, components, or any combination thereof.

When an element or layer is referred to as being “above” or “on” another element or layer, this includes not only a case where the element or layer is directly on the other element or layer, but also a case where another intervening layer or element is present therebetween. On the other hand, when an element is referred to as being “directly on” or “directly above” another element, it indicates that no other intervening elements or layers are present therebetween.

A conventional method of bringing particles into close contact with each other so as to minimize pores between particles in an all-solid battery has been proposed, and methods of manufacturing an all-solid battery by pressurizing the all-solid battery have been proposed. However, a method of manufacturing an all-solid battery, which was proposed in the past, has problems in that pores in the all-solid battery are not sufficiently removed, or the all-solid battery is damaged during a pressurizing process, resulting in a degradation in battery performance.

Therefore, there is a need for an apparatus for manufacturing an all-solid battery, which prevents the all-solid battery from being damaged even during a pressurizing process while sufficiently removing pores in the all-solid battery.

Hereinafter, an apparatus 10 for manufacturing an all-solid battery, according to an embodiment of the present disclosure, is described.

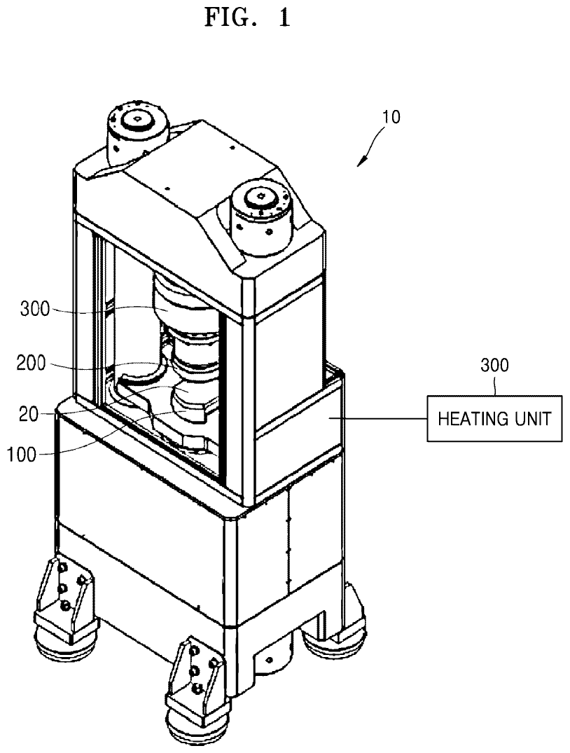

FIG. 1 is an example diagram of an apparatus for manufacturing an all-solid battery, which is provided according to an embodiment of the present disclosure.

Referring to FIG. 1, in order to solve the technical problems described above, an embodiment of the present disclosure provides an apparatus 10 for manufacturing an all-solid battery, which includes a holder 100 on which a workpiece 20 is placed, a pressurizing unit 200, and a heating unit 300 arranged in an area of the holder 100 or the pressurizing unit 200.

The holder 100 is a component having a surface on which the workpiece 20 is seated.

The pressurizing unit 200 is a component which pressurizes the workpiece 20 seated on the holder 100.

The heating unit 300 is a component which is arranged in an area of the holder 100 or the pressurizing unit 200 and applies heat to the workpiece 20.

At this time, the workpiece refers to those including a battery cell or a pouch-type battery. Furthermore, the battery cell refers to those including a monocell and a stacked cell and may mean that an all-solid battery is made through a process, such as pressurization, by including a solid-state positive electrode material, a negative electrode material, and a solid electrolyte.

The monocell may refer to a single cell including a positive electrode layer, a negative electrode layer, and a solid electrolyte layer, and the stacked cell may refer to a cell in which a plurality of monocells are stacked.

The stacked cell may be a cell having a bipolar structure widely known in the art.

Any positive electrode material may be used as long as the positive electrode material is commonly usable in a positive electrode of a lithium secondary battery. For example, the positive electrode material may be lithium oxide. Specifically, a layered compound, such as lithium cobalt oxide (LiCoO₂) or lithium nickel oxide (LiNiO₂), a compound substituted with one or more transition metals, lithium manganese oxide, such as LiMnO₃ or LiMn₂O₃, lithium copper oxide, vanadium oxide, such as LiV₃O₈, LiFe₃O₄, V₂O₅, or Cu₂V₂O₇, Ni-site type lithium nickel oxide, lithium manganese composite oxide, or any combination thereof may be used as the positive electrode material, but the present disclosure is not limited thereto.

Any negative electrode material may be used as long as the negative electrode material is commonly usable in a negative electrode of a lithium secondary battery. For example, carbon, such as non-graphitizable carbon or graphitic carbon (natural graphite or artificial graphite), metal composite oxide, such as LiₓFe₂O₃ (0≤x≤1), LiₓWO₂ (0≤x≤1), or SnₓMe₁₋ₓMe′_{y}O_{z} (Me: Mn, Fe, Pb, or Ge; Me′: Al, B, P, Si, Group 1, 2, or 3 element of the periodic table, or halogen; 0<x≤1; 1≤y≤3; 1≤z≤8), lithium metal, a lithium alloy, a silicon-based alloy, a tin-based alloy, metal oxide, such as SnO, SnO₂, PbO, PbO₂, Sb₂O₃, GeO, GeO₂, Bi₂O₃, or Bi₂O₄, conductive polymer, such as polyacetylene, Li-Co-Ni-based material, titanium oxide, lithium titanium oxide, or any combination thereof may be used, but the present disclosure is not limited thereto.

The solid electrolyte may include a sulfide-based material, such as Li₁₀GeP₂S₁₂ (LGPS), Li_{9.54}Si_{1.74}P_{1.44}S_{11.7}Cl_{0.3} (LSPSCI), or argyrodite, an oxide-based material, such as perovskite (LLTO), garnet (LLZO), NASICON, or LISICON, or a polymer-based material, such as PEO.

The solid electrolyte may be mixed with the positive electrode material to form a single layer. For example, a raw material powder of the solid electrolyte and a raw material powder of the positive electrode material may be mixed with each other to form the solid electrolyte layer and the positive electrode layer in a state of being mixed or adhered to each other.

In addition, the workpiece may have various shapes and sizes depending on the location, shape, or industrial field of a product in which the all-solid battery is used, and may be, for example, a battery cell having a disc coin shape, a square shape, etc.

Hereinafter, the holder 100 is described.

As described above, the holder 100 has a surface on which the workpiece 20 is seated.

In an embodiment, the holder 100 is not limited in the type, size, material, etc. thereof, and may be used in the pressurizing process of the workpiece 20 or the battery cell. Any holder of a type where an object to be pressurized may be placed and fixed should be interpreted as falling within the scope of the present disclosure.

On the other hand, in an embodiment, the holder 100 may further include the heating unit 300 which may be arranged in an area of the holder 100 and may apply heat to the workpiece 20. By further including the heating unit 300 as described above and heating and pressurizing the workpiece 20, the workpiece 20 may be compressed more densely. The heating unit 300 is not particularly limited and, for example, a cartridge heater, an induction, etc. may be used. However, the present disclosure is not limited to the above examples.

In an embodiment, the heating unit 300 may cause the temperature of the workpiece 20 to be 20° C. to 400° C., and in another example, may cause the temperature of the workpiece 20 to be 25° C. to 85° C. By using the heating unit 300 to increase the temperature of the workpiece 20 as described above, the flexibility of the internal materials of the workpiece 20 is improved so that a product damage phenomenon caused by stress during the pressurizing process may be prevented and the homogeneity of the workpiece 20 may be improved by enabling the pressurizing process to a higher pressure.

In an embodiment, the holder 100 may further include a temperature control part (not shown) which controls the driving of the heating unit 300. When using the heating unit 300, it is necessary to control the process conditions of the heating unit 300 depending on the type and process conditions of a battery to be used. Therefore, the temperature control part (not shown) may be further included.

In an embodiment, the holder 100 may further include a fixing unit (not shown) arranged adjacent to at least a portion of the workpiece 20. The fixing unit (not shown) is not particularly limited, and any component capable of fixing the workpieces during the pressurizing process should be interpreted as falling within the scope of the present disclosure.

In an embodiment, the holder 100 may further include a buffer member (not shown) arranged adjacent to at least a portion of the workpiece 20. The buffer member (not shown) is also not particularly limited, and any buffer member (not shown) capable of preventing volume expansion or product damage from occurring when the workpiece expands toward the surroundings during the pressurizing process should be interpreted as falling within the scope of the present disclosure.

Hereinafter, the pressurizing unit 200 is described.

The pressurizing unit 200 may be arranged above the surface of the holder 100 and may pressurize the workpiece 20 seated on the holder 100 to a preset pressure.

In an embodiment, the pressurizing unit 200 may have a flat pressurizing surface so as to uniformly pressurize the workpiece 20 seated on the holder 100. In this case, the pressurizing unit 200 may be made of a material having a certain stiffness, which prevents the pressurizing surface of the pressurizing unit 200 and the workpiece 20 from being adsorbed by the pressurizing pressure.

In an embodiment, the pressurizing unit 200 may further include a pressurizing pad (not shown) in an area which comes into contact with the workpiece 20. The pressurizing pad (not shown) may use various materials depending on the type and size of the workpiece 20.

In an embodiment, the pressurizing pad (not shown) may include an elastic material. In case that the workpiece 20 is a battery cell, the battery cell may be damaged during the pressurizing process using the pressurizing unit 200. Therefore, the damage to the battery cell may be prevented by arranging the pressurizing pad (not shown) including an elastic material in an area where the pressurizing unit 200 comes into contact with the workpiece 20.

In an embodiment, the preset pressure may vary depending on the thickness and type of the positive electrode material, the negative electrode material, and the solid electrolyte included in the target workpiece 20 and may vary depending on the intended use of the all-solid battery to be manufactured. As an example, the pressurizing unit 200 may pressurize to a pressure of 2,500 kN or less.

In an embodiment, the pressurizing unit 200 may further include a pressure control part (not shown) which controls the pressurizing pressure of the pressurizing unit 200. The pressure control part (not shown) is not particularly limited, and any pressure control part may be interpreted as falling within the scope of the present disclosure as long as the pressure control part may be easily selected by those of ordinary skill in the art.

In an embodiment, the pressurizing unit 200 may further include a unit control part (not shown) which controls the pressurizing time of the pressurizing unit 200 and the movement of the unit. The unit control part (not shown) is not particularly limited, and any unit control part may be interpreted as falling within the scope of the present disclosure as long as the unit control part may be easily selected by those of ordinary skill in the art.

In an embodiment, the unit control part (not shown) may cause the pressurizing unit 200 to pressurize the workpiece 20 for 5 seconds to 15 seconds. In case that the pressurizing process of the pressurizing unit 200 is so excessively short as less than 5 seconds, the pressurizing process of the workpiece 20 may not be sufficient. In contrast, in case that the pressurizing process of the pressurizing unit 200 on the workpiece 20 exceeds 15 seconds, the workpiece 20 may be damaged.

In an embodiment, the pressurizing unit 200 may further include the heating unit 300 which may be arranged in an area of the pressurizing unit 200 and may apply heat to the workpiece 20. By further including the heating unit 300 as described above and heating and pressurizing the workpiece 20, the workpiece 20 may be compressed more densely. The heating unit 300 is not particularly limited and, for example, a cartridge heater, etc. may be used, but the present disclosure is not limited to the above examples.

In an embodiment, the heating unit 300 may cause the temperature of the workpiece 20 to be 20° C. to 400° C., and in another example, may cause the temperature of the workpiece 20 to be 25° C. to 85° C. By using the heating unit 300 to increase the temperature of the workpiece 20 as described above, the flexibility of the internal materials of the workpiece 20 is improved so that a product damage phenomenon caused by stress during the pressurizing process may be prevented and the homogeneity of the workpiece 20 may be improved by enabling the pressurizing process to a higher pressure.

In an embodiment, the apparatus 10 for manufacturing a battery cell may further include a temperature control part (not shown) which controls the driving of the heating unit 300 arranged in an area of the holder 100. When using the heating unit 300, it is necessary to control the process conditions of the heating unit 300 depending on the type and process conditions of a battery to be used. Therefore, the temperature control part (not shown) may be further included.

Hereinafter, a buffer auxiliary member 400 is described.

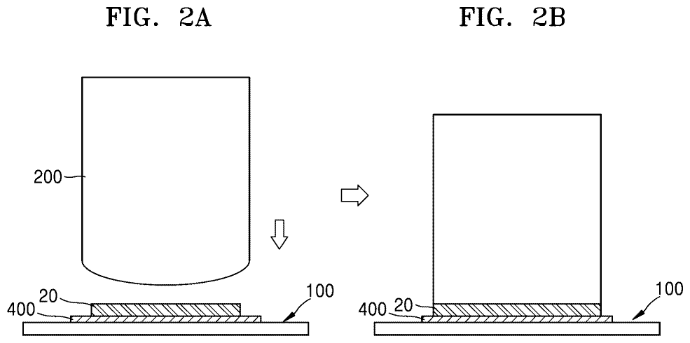

FIGS. 2A to 4B are example diagrams of an apparatus for manufacturing a battery cell, according to an embodiment of the present disclosure.

Referring to FIGS. 2A to 4B, in an embodiment, the apparatus 10 for manufacturing a battery cell may further include a buffer auxiliary member 400 which is arranged in an area adjacent to the workpiece 20 and distributes the pressure applied to the workpiece 20.

More specifically, in an embodiment, the apparatus 10 for manufacturing a battery cell may further include the buffer auxiliary member 400 arranged in at least one of a position between the workpiece 20 and the pressurizing unit 200 and a position between the workpiece 20 and the holder 100.

In an embodiment, by further including the buffer auxiliary member 400, the buffer auxiliary member 400 may pressurize the workpiece 20 more stably in the process of pressurizing the workpiece 20 by using the pressurizing unit 200.

In other words, when the pressurizing process is performed, the buffer auxiliary member 400 is positioned between the workpiece 20 and the holder 100 or between the workpiece 20 and the pressurizing unit 200 to reduce the minute thickness deviation of the workpiece 20. Accordingly, the pressure is uniformly distributed over the entire surface of the workpiece 20 to prevent damage to the workpiece 20, prevent deformation in a lateral direction and prevent a short circuit of the workpiece (e.g., the battery cell). The buffer auxiliary member 400 may include a member of various forms, such as a form which may completely cover the workpiece 20 or a form in which the workpiece 20 may be arranged within the buffer auxiliary member 400, and it is preferable that the size of the buffer auxiliary member 400 is equal to or greater than the size of the workpiece 20.

In an embodiment, it is preferable that the buffer auxiliary member 400 uses a member which is thin and is capable of covering the entire workpiece 20, and at the same time, it is preferable to select a member which has a flexible structure so that stretching does not occur during the pressurizing process using the pressurizing unit 200 and damage is not caused to the surface or interior of the workpiece 20. Examples of the buffer auxiliary member 400 include gaskets, paper, pouch films, paper pouches, silicone-based films, or release films, but the present disclosure is not limited to the above examples.

Referring to FIGS. 2A and 2B, in an embodiment, the apparatus 10 for manufacturing a battery cell may include the buffer auxiliary member 400 arranged between the workpiece 20 and the holder 100. By arranging the buffer auxiliary member 400 between the workpiece 20 and the holder 100, a phenomenon that a lower end area of the workpiece 20 is excessively pressurized may be prevented.

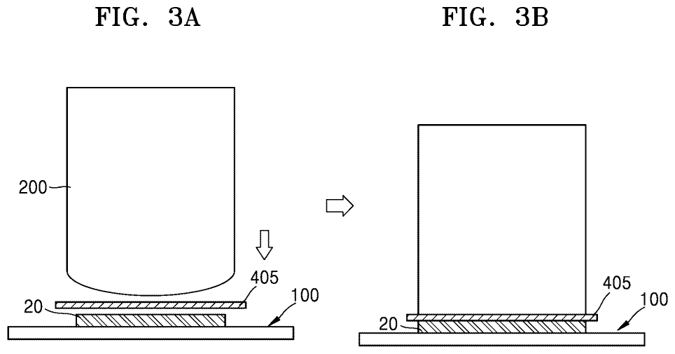

Referring to FIGS. 3A and 3B, in an embodiment, the apparatus 10 for manufacturing a battery cell may include a buffer auxiliary member 405 arranged between the workpiece 20 and the pressurizing unit 200. By arranging the buffer auxiliary member 405 between the workpiece 20 and the pressurizing unit 200, a phenomenon that a specific area of the workpiece 20 is excessively pressurized may be prevented.

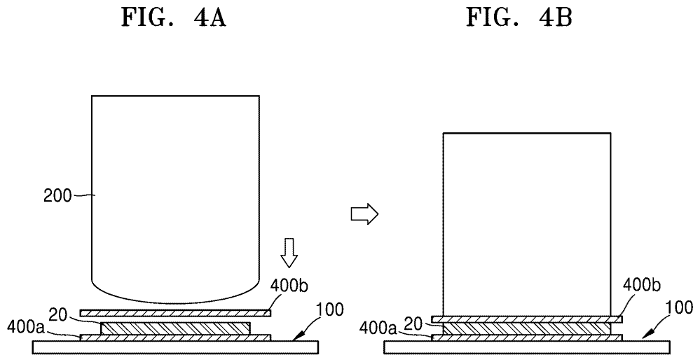

Referring to FIGS. 4A and 4B, in an embodiment, the apparatus 10 for manufacturing a battery cell may include a first buffer auxiliary member 400a and a second buffer auxiliary member 400b. At this time, the first buffer auxiliary member 400a is arranged between the workpiece 20 and the holder 100, and the second buffer auxiliary member 400b is arranged between the workpiece 20 and the pressurizing unit 200.

Although not illustrated in the drawings, in an embodiment, the apparatus 10 for manufacturing a battery cell may include a buffer auxiliary member 400 arranged inside the workpiece 20. For example, the apparatus 10 for manufacturing a battery cell may include a paper pouch, in which the workpiece 20 is arranged inside, as the buffer auxiliary member 400.

Due to having the structure described above, the pressure may be distributed to both upper and lower areas of the workpiece 20, which may improve the quality of the final product of the workpiece 20.

In an embodiment, the apparatus 10 for manufacturing an all-solid battery may further include a pressure measuring unit 400 which measures the pressure applied to the workpiece 20. In this case, the pressure measuring unit 400 may be a sensor which measures the pressure applied to the workpiece 20, such as a load cell.

As described above, the workpiece 20 usable in the apparatus 10 for manufacturing an all-solid battery, which is provided according to an embodiment of the present disclosure, may have various shapes and sizes, and accordingly, the apparatus 10 for manufacturing an all-solid battery may measure the pressure applied to the workpiece 20 through the pressure measuring unit 400 and apply a uniform pressure to the workpiece 20.

The apparatus 10 for manufacturing an all-solid battery, according to an embodiment of the present disclosure, may measure the used pressurizing pressure by using the pressure measuring unit 400 and record the measured used pressurizing pressure, which enables mass production of all-solid batteries having a constant battery performance.

In an embodiment, the pressure measuring unit 400 which measures the pressure applied to the workpiece 20 may be connected to and arranged in the pressurizing unit 200.

In another embodiment, the pressure measuring unit 400 may be arranged on the holder 100 and may measure the pressure applied while the pressurizing unit 200 pressurizes the workpiece 20. Alternatively, the pressure measuring unit 400 may be arranged on both the holder 100 and the pressurizing unit 200.

The foregoing description of the present disclosure is for illustrative purposes only, and those of ordinary skill in the art to which the present disclosure belongs will understand that modifications into other specific forms may be made thereto without changing the technical spirit or essential features of the present disclosure. Therefore, it should be understood that the embodiments described above are illustrative in all respects and are not restrictive. For example, components described as a single entity may be implemented in a distributed manner. Similarly, components described as distributed may be implemented in a combined manner.

The scope of the present disclosure is indicated by the claims described below, and all changes or modifications derived from the meaning and scope of the claims and the equivalent concepts thereof should be interpreted as falling within the scope of the present disclosure.

### INDUSTRIAL APPLICABILITY

The present disclosure relates to an apparatus for manufacturing an all-solid battery and may be used to manufacture an all-solid battery.

1. An apparatus for manufacturing an all-solid battery, the apparatus comprising:
a holder having a surface on which a workpiece is seated;
a pressurizing unit arranged above the surface of the holder and configured to pressurize the workpiece seated on the holder to a preset pressure; and
a heating unit arranged in an area of the holder or the pressurizing unit and configured to apply heat to the workpiece.

2. The apparatus of claim 1, wherein the heating unit is further configured to heat the workpiece to a temperature of 20° C. to 400° C.

3. The apparatus of claim 1, further comprising a temperature control part arranged on a side surface of the heating unit and configured to control a temperature of the heating unit.

4. The apparatus of claim 1, further comprising a pressure measuring unit configured to measure a pressure applied to the workpiece while the pressurizing unit pressurizes the workpiece.

5. An apparatus for manufacturing an all-solid battery, the apparatus comprising:
a holder having a surface on which a workpiece is seated;
a pressurizing unit arranged above the surface of the holder and configured to pressurize the workpiece seated on the holder to a preset pressure; and
a buffer auxiliary member arranged in an area adjacent to the workpiece and configured to distribute a pressure applied to the workpiece.

6. The apparatus of claim 5, wherein the buffer auxiliary member comprises a first buffer auxiliary member arranged between the holder and the workpiece.

7. The apparatus of claim 5, wherein the buffer auxiliary member comprises a second buffer auxiliary member arranged between the workpiece and the pressurizing unit.

8. The apparatus of claim 5, further comprising a pressure measuring unit configured to measure a pressure applied to the workpiece while the pressurizing unit pressurizes the workpiece.

9. The apparatus of claim 8, wherein the pressure measuring unit is connected to and arranged in the pressurizing unit.
